(19) United States
(12) Patent Application Publication
(10) Pub. No.: US 2008/0258547 A1
(43) Pub. Date: Oct. 23, 2008

(54) AIRCRAFT BRAKE CONTROL ARCHITECTURE HAVING IMPROVED POWER DISTRIBUTION AND REDUNDANCY

(76) Inventors: Mihai Ralea, Boonton Township, NJ (US); Bill May, Tipp City, OH (US); Henry Grant, Port Henry, NY (US)

Correspondence Address: DON W. BULSON (GRCO);RENNER, OTTO, BOISSELLE & SKLAR, LLP, 1621 EUCLID AVENUE, 19TH FLOOR, CLEVELAND, OH, 44115, US

(21) Appl. No.: 11/736,603

(22) Filed: Apr. 18, 2007

(51) Int. Cl. B60T 8/88; B60T 13/66; B64C 25/42

(52) U.S. Cl. 303/122; 244/110 A; 303/20

(57) ABSTRACT

An electromechanical braking system for an aircraft, including a first power conversion module (PCM) and a second power conversion module (PCM), each configured to receive power from a respective independent power source on the aircraft. The system further includes at least one brake system control unit (BSCU) for converting an input brake command signal into a brake clamp force command signal. At least a first brake control module (BCM) and a second brake control module (BCM) are provided, each configured to receive the brake clamp force command signal from the at least one BSCU and to output a primary brake clamp force command signal and an alternate brake clamp force command signal based on the received brake clamp force command signal. A first electromechanical actuator controller (EMAC) and a second electromechanical actuator controller (EMAC) are provided, each configured to convert a brake clamp force command signal to at least one electromechanical actuator drive control signal. The first EMAC is operative based on the primary brake clamp force command signal from the first BCM or, in the event of a failure disabling the first BCM, based on the alternate brake clamp force command signal from the second BCM. The second EMAC is operative based on the primary brake clamp force command signal from the first BCM or, in the event of a failure disabling the first BCM, based on the alternate brake clamp force command signal from the second BCM. The first EMAC receives its operating power from the first PCM, and the second EMAC receives its operating power from the second PCM.

### TECHNICAL FIELD

The present invention relates generally to brake systems for vehicles, and more particularly to an electromechanical braking system for use in aircraft.

### BACKGROUND OF THE INVENTION

Various types of braking systems are known. For example, hydraulic, pneumatic and electromechanical braking systems have been developed for different applications.

An aircraft presents a unique set of operational and safety issues. As an example, uncommanded braking due to failure can be catastrophic to an aircraft during takeoff. On the other hand, it is similarly necessary to have virtually fail-proof braking available when needed (e.g., during landing).

If one or more engines fail on an aircraft, it is quite possible that there will be a complete or partial loss of electrical power. In the case of an electromechanical braking system, loss of electrical power, failure of one or more system components, etc. raises the question as to whether and how adequate braking may be maintained. It is critical, for example, that braking be available during an emergency landing even in the event of a system failure.

In order to address such issues, various levels of redundancy have been introduced into aircraft brake control architectures. In the case of electromechanical braking systems, redundant powers sources, brake system controllers, electromechanical actuator controllers, etc. have been utilized in order to provide satisfactory braking even in the event of a system failure. For example, U.S. Pat. Nos. 6,296,325 and 6,402,259 describe aircraft brake control architectures providing various levels of redundancy in an electromechanical braking system to ensure satisfactory braking despite a system failure.

Nevertheless, it is still desirable to continue to improve the level of braking available in electromechanical braking systems even in the event of a system failure.

### SUMMARY OF THE INVENTION

According to one feature of the present invention, an electromechanical braking system for an aircraft is provided. The system includes a first power conversion module (PCM) and a second power conversion module (PCM), each configured to receive power from a respective independent power source on the aircraft. In addition, the system includes at least one brake system control unit (BSCU) for converting an input brake command signal into a brake clamp force command signal. At least a first brake control module (BCM) and a second brake control module (BCM) are provided, each configured to receive the brake clamp force command signal from the at least one BSCU and to output a primary brake clamp force command signal and an alternate brake clamp force command signal based on the received brake clamp force command signal. A first electromechanical actuator controller (EMAC) and a second electromechanical actuator controller (EMAC) are provided, each configured to convert a brake clamp force command signal to at least one electromechanical actuator drive control signal. The first EMAC is operative based on the primary brake clamp force command signal from the first BCM or, in the event of a failure disabling the first BCM, based on the alternate brake clamp force command signal from the second BCM. The second EMAC is operative based on the primary brake clamp force command signal from the first BCM or, in the event of a failure disabling the first BCM, based on the alternate brake clamp force command signal from the second BCM. The first EMAC receives its operating power from the first PCM, and the second EMAC receives its operating power from the second PCM.

In accordance with a particular aspect, the first BCM receives its operating power from the first PCM and the second BCM receives its operating power from the second PCM.

According to another aspect, the first EMAC and the second EMAC are each configured to drive a respective set of electromechanical actuators on a same wheel of the aircraft.

In yet another aspect, the braking system further includes a third EMAC and a fourth EMAC. The third EMAC is operative based on the primary brake clamp force command signal from the second BCM or, in the event of a failure disabling the second BCM, based on the alternate brake clamp force command signal from the first BCM. The fourth EMAC is operative based on the primary brake clamp force command signal from the second BCM or, in the event of a failure disabling the second BCM, based on the alternate brake clamp force command signal from the first BCM.

In still another aspect, the third EMAC receives its operating power from the second PCM, and the fourth EMAC receives its operating power from the second PCM.

According to still another aspect, the first BCM receives its operating power from the first PCM and the second BCM receives its operating power from the second PCM.

With yet another aspect, the third EMAC and the fourth EMAC are each configured to drive a respective set of electromechanical actuators on a same wheel of the aircraft.

According to another aspect, the first EMAC and the second EMAC are each configured to drive a respective set of electromechanical actuators on a different same wheel of the aircraft.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a block diagram of an aircraft brake control architecture in accordance with an exemplary embodiment of the present invention.

### DETAILED DESCRIPTION OF THE INVENTION

The present invention will now be described with reference to the drawing, in which like reference labels are used to refer to like elements throughout.

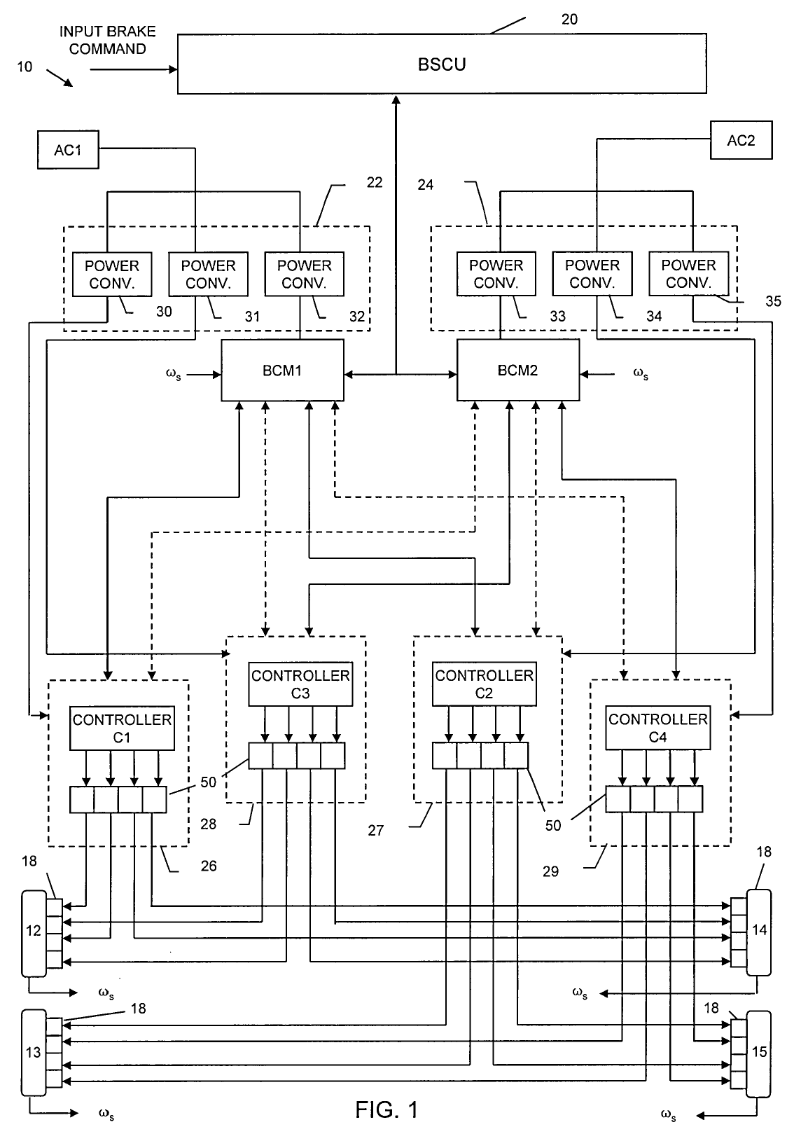

Referring to FIG. 1, a braking system 10 for an aircraft is shown in accordance with the invention. The braking system 10 is shown as providing braking with respect to four wheels 12-15 each having four independent actuators 18. Wheels 12 and 13 represent a first wheel pair corresponding to a left side of the aircraft. Similarly, wheels 14 and 15 represent a second wheel pair corresponding to the right side of the aircraft. It will be appreciated, however, that the present invention may be utilized with essentially any number of wheels, actuators per wheel, etc.

The braking system 10 includes an upper level controller 20, or brake system control unit (BSCU), for providing overall control of the system 10. Such BSCU controller may be in accordance with any conventional device such as that described in the aforementioned U.S. Pat. Nos. 6,296,325 and 6,402,259.

The controller 20 receives as an input an input brake command indicative of the desired amount of braking. For example, the input brake command is derived from the brake pedals within the cockpit of the aircraft, the input brake command indicating the degree to which the brake pedals are depressed, and hence the desired amount of braking. Based on such input, the controller 20 operates to provide a brake clamp force command signal intended to provide the desired amount of braking in relation to the input brake command.

The braking system 10 further includes a pair of power conversion modules (PCMs) 22 and 24. Each PCM 22 and 24 provides power conversion to a corresponding plurality of electromechanical actuator controllers (EMACs) (e.g., EMACs 26, 28 and 27, 29, respectively). More specifically, PCM 22 includes a power conversion module made up of power converters 30, 31 and 32. Each of the power converters 30-32 receives input power from a first aircraft power source AC1 (e.g., power generated by a first engine of the aircraft). Power converter 30 converts the power from AC1 into appropriate AC and DC voltage levels that are provided to EMAC 26 to provide appropriate operating power to EMAC 26 and the actuators 18 driven thereby. Similarly, power converter 31 converts power from AC1 to AC and DC voltage levels that are provided to EMAC 28 to drive the EMAC 28 and its corresponding actuators 18.

Power converter 32 converts the power from AC1 to appropriate DC voltage levels that are provided to power a brake control and communications module (BCM1) included in the braking system 10. BCM1 receives brake clamp force command signals from the controller 20 and provides the brake clamp force command signals on separate primary and alternate channels in order to drive respective EMACs as discussed more fully below.

PCM 24 is similar to PCM 22 in that it includes a power conversion module having power converters 33, 34 and 35. Each of the power converters 33-35 receives input power from a second aircraft power source AC2 that is independent from the power source AC1 (e.g., power generated by a second engine of the aircraft). By independent, it is meant that the power sources AC1 and AC2 do not share a common power source. Power converter 34 converts the power from AC2 into appropriate AC and DC voltage levels that are provided to EMAC 27 to provide appropriate operating power to EMAC 27 and the actuators 18 driven thereby. Similarly, power converter 35 converts power from AC2 to AC and DC voltage levels that are provided to EMAC 29 to drive the EMAC 29 and its corresponding actuators 18.

Power converter 33 provides operating power for brake control and communications module BCM2 also included in the braking system 10. Like BCM1, BCM2 also receives brake clamp force command signals from the controller 20 and provides the brake clamp force command signals on separate primary and alternate channels as discussed more fully below. BCM1 and BCM2 are configured to operate redundantly such that if either BCM1 or BCM2 were to fail, the remaining BCM would function to provide brake clamp force command signals to each of EMACs 26-29.

For example, BCM1 and BCM2 each receive a brake clamp force command signal from the controller 20 based on the input brake command, antiskid operations, etc. BCM1 receives the brake clamp force command signal and outputs corresponding primary brake clamp force command signals and alternate brake clamp force command signals. More specifically, BCM1 provides a primary brake clamp force command signal (represented by solid line) to primary channels of EMAC 26 and EMAC 27. In addition, BCM1 provides an alternate brake clamp force command signal (represented by broken line) to alternate channels of EMAC 28 and EMAC 29.

Similarly, BCM2 receives the brake clamp force command signal and outputs corresponding primary brake clamp force command signals and alternate brake clamp force command signals. In particular, BCM2 provides a primary brake clamp force command signal (represented by solid line) to primary channels of EMAC 28 and EMAC 29. Moreover, BCM2 provides an alternate brake clamp force command signal (represented by broken line) to alternate channels of EMAC 26 and EMAC 27.

According to the exemplary embodiment, the primary and alternate brake clamp force command signals output by each of BCM1 and BCM2 generally mirror each other. Under normal operating conditions, BCM1 provides primary control of EMAC 26 and EMAC 27. Similarly, BCM2 provides primary control of EMAC 28 and EMAC 29. In the event of a system failure that may cause either BCM1 or BCM2 to fail, however, the remaining BCM controls the EMACs primarily controlled by the failed BCM via the alternate channels of the remaining BCM. For example, if BCM1 was to fail (e.g., via component failure, failure of power converter 32, etc.), EMAC 26 and EMAC 27 are configured to instead obtain brake clamp force command signals via the alternate signals provided by BCM2. Similarly, if BCM2 was to fail, EMAC 28 and EMAC 29 are configured to obtain brake clamp force command signals via the alternate signals provided by BCM1.

Each of EMACs 26-29 includes a respective controller C1-C4. The controllers C1-C4 are configured to receive brake clamp force command signals from the respective primary and alternate BCMs. Based on the brake clamp force command signals, each controller C1-C4 converts the brake clamp force command signals to electromechanical actuator drive control signals that are provided to the respective actuator drivers 50 included within the same EMAC. The actuator drive control signals are in turn provided to a corresponding actuator 18 to drive the actuator and thereby apply the desired brake clamp force to the particular wheel.

Although not shown, sensors for wheel speed are included at each of the wheels 12-15 and provide measured wheel speed ωₛ. Such values are fed back to BCM1 and BCM2 in order to carry out conventional brake control processing, antiskid processing, etc.

As is represented in FIG. 1, EMAC 26 controls two of four actuators 18 on wheels 12 and 14. EMAC 27 controls two of four actuators on wheels 13 and 15. EMAC 28 controls the remaining two of four actuators 18 on wheels 12 and 14, and EMAC 29 controls the remaining two of four actuators 18 on wheels 13 and 15.

In view of the above, it will be appreciated that the braking system 10 of the present invention includes PCM 22 and PCM 24, each configured to receive power from a respective independent power source on the aircraft (e.g., AC1 and AC2). BCM1 and BCM2 are each configured to receive the brake clamp force command signal from the controller 20, and to output a primary brake clamp force command signal and an alternate brake clamp force command signal based on the received brake clamp force command signal.

EMAC 26 is operative based on the primary brake clamp force command signal from BCM1 or, in the event of a failure within the system, based on the alternate brake clamp force command signal from the BCM2. EMAC 27 also is operative based on the primary brake clamp force command signal from BCM1 or, in the event of a failure within the system, based on the alternate brake clamp force command signal from BCM2. However, EMAC 26 receives its operating power from PCM 22 whereas EMAC 27 receives its operating power from PCM 24. As described above, PCM 22 and PCM 24 are operative based on independent power sources AC1 and AC2, respectively.

BCM1 receives its operating power from PCM 22 and the BCM2 receives its operating power from PCM 24. EMAC 26 and the EMAC 27 are each configured to drive a respective set of electromechanical actuators 18 on a same wheel (e.g., wheel 12 or wheel 14) of the aircraft. EMAC 28 is operative based on the primary brake clamp force command signal from the BCM2 or, in the event of a failure within the system, based on the alternate brake clamp force command signal from the first BCM1. EMAC 29 is operative based on the primary brake clamp force command signal from BCM2 or, in the event of a failure within the system, based on the alternate brake clamp force command signal from BCM1.

EMAC 28 receives its operating power from the PCM 24, and EMAC 29 receives its operating power from PCM 24. EMAC 28 and the EMAC 29 are each configured to drive a respective set of electromechanical actuators on a same wheel (e.g., wheel 13 or wheel 15) of the aircraft.

Accordingly, if a PCM such as PCM 22 were to fail (e.g., as a result of a failure of AC1), BCM1, EMAC 26 and EMAC 28 would be disabled. However, 50% of full braking would still be available to each of the wheels via BCM2, EMAC 27 and EMAC 29 via its respective actuators 18. By overdriving the respective actuators 18, greater than 50% of full braking may be achieved as will be appreciated.

In the event one of the BCMs was to fail (e.g., due to component failure or failure of power converter 32 or 33), the remaining BCM would remain operable. Thus, for example, if BCM1 were to fail it would no longer provide primary control to EMAC 26 and EMAC 27. However, EMAC 26 and EMAC 27 are configured to detect such failure and instead rely on the alternate brake clamp command signals provided via BCC2. Thus, 100% full braking remains available.

If one of the power converters supplying power to the EMACs were to fail in one of the PCM, the remaining EMACs would remain operable. For example, if power converter 30 in PCM 22 was to fail, EMAC 26 would become disabled but EMACs 27, 28 and 29 would remain operative. Thus, 75% of full braking would remain available, and more than 75% if the remaining actuators are overdriven. Similarly, if an EMAC itself were to fail, 75% or more of full braking would remain available.

If a given actuator 18 were to fail, 94% of full braking would remain available, and more if the remaining actuators 18 are overdriven. If one of the sensors (e.g., wheel speed, torque, etc.) were to fail, the value(s) of one of the remaining sensors could be used to estimate the wheel speed, torque, etc. of the failed sensor. In such manner, again 100% of full braking remains available.

Accordingly, those having ordinary skill will appreciate that the present invention provides an improved level of braking available in electromechanical braking systems even in the event of a system failure.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. An electromechanical braking system for an aircraft, comprising:
a first power conversion module (PCM) and a second power conversion module (PCM), each configured to receive power from a respective independent power source on the aircraft;
at least one brake system control unit (BSCU) for converting an input brake command signal into a brake clamp force command signal;
at least a first brake control module (BCM) and a second brake control module (BCM), each configured to receive the brake clamp force command signal from the at least one BSCU and to output a primary brake clamp force command signal and an alternate brake clamp force command signal based on the received brake clamp force command signal; and
at least a first electromechanical actuator controller (EMAC) and a second electromechanical actuator controller (EMAC), each configured to convert a brake clamp force command signal to at least one electromechanical actuator drive control signal,
wherein the first EMAC is operative based on the primary brake clamp force command signal from the first BCM or, in the event of a failure disabling the first BCM, based on the alternate brake clamp force command signal from the second BCM,
the second EMAC is operative based on the primary brake clamp force command signal from the first BCM or, in the event of a failure disabling the first BCM, based on the alternate brake clamp force command signal from the second BCM, and
the first EMAC receives its operating power from the first PCM, and the second EMAC receives its operating power from the second PCM.

2. The braking system of claim 1, wherein the first BCM receives its operating power from the first PCM and the second BCM receives its operating power from the second PCM.

3. The braking system of claim 1, wherein the first EMAC and the second EMAC are each configured to drive a respective set of electromechanical actuators on a same wheel of the aircraft.

4. The braking system of claim 1, further comprising a third EMAC and a fourth EMAC,
wherein the third EMAC is operative based on the primary brake clamp force command signal from the second BCM or, in the event of a failure disabling the second BCM, based on the alternate brake clamp force command signal from the first BCM, and
the fourth EMAC is operative based on the primary brake clamp force command signal from the second BCM or, in the event of a failure disabling the second BCM, based on the alternate brake clamp force command signal from the first BCM.

5. The braking system of claim 4, wherein the third EMAC receives its operating power from the second PCM, and the fourth EMAC receives its operating power from the second PCM.

6. The braking system of claim 5, wherein the first BCM receives its operating power from the first PCM and the second BCM receives its operating power from the second PCM.

7. The braking system of claim 4, wherein the third EMAC and the fourth EMAC are each configured to drive a respective set of electromechanical actuators on a same wheel of the aircraft.

8. The braking system of claim 7, wherein the first EMAC and the second EMAC are each configured to drive a respective set of electromechanical actuators on a different same wheel of the aircraft.
